(19) United States
(12) Patent Application Publication
(10) Pub. No.: US 2006/0104096 A1
(43) Pub. Date: May 18, 2006

(54) System and method for monitoring power supply operation

(76) Inventor: Donald E. Alfano, Round Rock, TX (US)

Correspondence Address: HOWISON & ARNOTT, L.L.P, P.O. BOX 741715, DALLAS, TX, 75374-1715, US

(21) Appl. No.: 10/987,569

(22) Filed: Nov. 12, 2004

(51) Int. Cl. H02M 1/12

(52) U.S. Cl. 363/40

(57) ABSTRACT

A power supply for a portable electronic device includes power circuitry for converting AC power from an AC power supply to DC power for the portable device. A processor is coupled to the power circuitry for receiving a plurality of parameters. The processor determines the status of the power supply responsive to the plurality of the parameters and generates a signal to drive an indicator providing an indication of the status of the power supply.

### TECHNICAL FIELD OF THE INVENTION

This invention relates to power supplies, and more particularly, to a system and method for monitoring whether a power supply is operating correctly or is defective.

### BACKGROUND OF THE INVENTION

The expanding use of portable electronic devices has greatly increased the use of power supplies which may be plugged into these electronic devices and into a standard AC power outlet found in all homes and places of business. The AC power supply includes power circuitry having a first connection to the AC power source and a second connection that plugs into a power input of the portable device. In most configurations, the power supply uses the provided AC power source to first charge a battery within the portable electronic device, and after the battery has been fully charged, the portable electronic device operates off of the power provided from the power supply. Many of the power supplies that are connected to portable electronic devices comprise a black box type apparatus which may have a light thereon to indicate when the power supply is plugged into a power source.

One problem with power supplies of this type is the inability of a user to determine whether or not the power supply is functioning correctly. If an electronic device is plugged into the power supply and the battery within the power supply will not charge, the user of the portable electronic device is likely to infer that there is some type of problem with the power supply. While in some cases this may be true, alternatives exist for problems with the battery packs, the portable electronic device or the charging circuitry within the portable electronic device, each of which may also cause the problems to which a user is attributing the malfunctioning of the power supply. When a user of a portable electronic device makes a determination that the power supply is malfunctioning, the user will normally return the power supply to a manufacturer and is provided with a new power supply to replace the one they believe is malfunctioning. The manufacturer tests the power supply to determine whether or not it is actually malfunctioning. However, since alternative malfunctions other than the power supply may be the cause for the problem a user is experiencing, many power supplies that are operating correctly may be returned to the manufacturer needlessly. This requires the manufacturer to go to a great deal of time and expense in first receiving old power supplies, returning new ones and testing supposedly malfunctioning power supplies provided to the manufacturer. The cost involved in these operations involving returned power supplies can be prohibitive to the portable electronic device manufacturers due to the thin margins normally utilized in the manufacture and sale of portable electronic devices and their associated power supplies. Thus, there is a need for a system and method to enable the user of a power supply associated with a portable electronic device to quickly and easily determine whether the power supply is operating correctly without being required to return the power supply to the manufacturer and incur the costs associated with this method of operation.

### SUMMARY OF THE INVENTION

The present invention disclosed and claimed herein, in one aspect thereof, comprises a power supply for a portable electronic device. The power supply includes an AC power interface for connecting the power supply to an AC power source. A DC power interface enables interfacing of the power supply with the portable electronic device. Power circuitry interconnects the AC and DC power interfaces and converts AC power from the AC power supply to DC power for the portable device. A processor coupled to the power circuitry receives a plurality of parameters from the power circuitry and enables the processor to determine a status of the power supply responsive to the parameters. The processor further generates a signal indicating the status of the power supply. An indicator responsive to the signal from the processor provides an indication of the status of the power supply to a user.

### BRIEF DESCRIPTION OF THE DRAWINGS

Further features and advantages will become apparent from the following and more particular description of the preferred and other embodiments of the invention, as illustrated in the accompanying drawings in which like reference character generally refer to the same parts or elements throughout the views, and in which:

FIG. 1 is a schematic diagram of a power supply;

FIG. 2 is a block diagram of the power supply including self monitoring functionalities;

FIG. 3 is a block diagram of a processor for use with the power supply of FIG. 2;

FIG. 4 is a schematic diagram of the circuitry for implementing self monitoring functionality within a power supply;

FIG. 5 is an illustration of a table stored within a memory of the processor used for implementing a power supply containing self monitoring functionalities; and

FIG. 6 is a flow diagram illustrating the operation of a power supply having self monitoring functionalities.

### DETAILED DESCRIPTION OF THE INVENTION

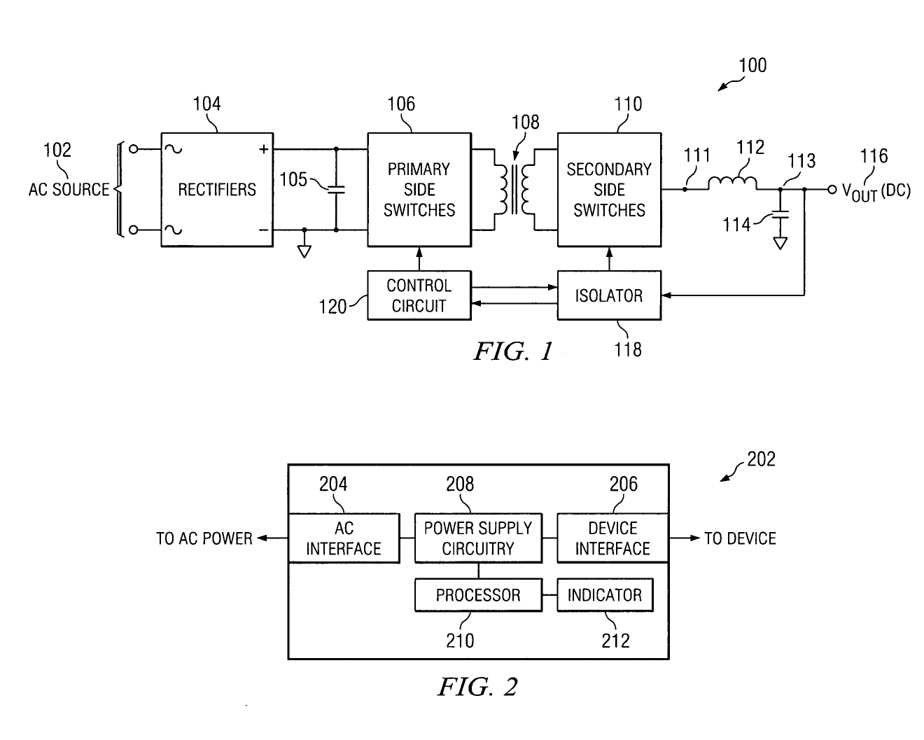

Referring now to the drawings, and more particularly to FIG. 1, there is illustrated a general block diagram of a power supply 100. The power supply 100 has an AC power source 102 applied to its inputs. The AC power source 102 is applied to input rectifiers 104 which convert the AC current of the AC power source 102 into a unidirectional DC current. The outputs of the rectifiers 104 are connected to the inputs of primary side switches 106. Also connected between the inputs of primary side switches 106 is a capacitor 105. The outputs of the primary side switches 106 are connected to the inputs of a primary side of transformer 108. The secondary side of transformer 108 is connected to the secondary side switches 110. The output of the secondary side switches 110 are connected at node 111 to an inductor 112. The opposite side of inductor 112 is connected to the output voltage node 113 that provides the output voltage 116. Connected between the node 113 and ground is a capacitor 114. The output voltage node 113 also provides feedback to an isolator circuit 118 isolating the primary side switches 106 from the secondary side switches 110. The output of the isolator is provided to a control circuit 120. The control circuit 120 uses the output voltage VOUT 116 to provide control signals to the primary side switches 106 and to the secondary side switches 110. The control signals from the control circuit 120 to the secondary side switches 110 are provided through the isolator 118. When the AC source 102 is operating, the power supply 100 provides an output voltage VOUT 116 which may be used to power a connected portable electronic device that is interconnected with the power supply 100. In this manner, the portable electronic device may charge its battery for completely mobile operation or, once the battery is charged, the power supply may be used to power the circuitry of the portable electronic device. A portable electronic device for use with the power supply described with respect to the present disclosure may include a laptop computer, personal data assistant, electronic gaming system, or any number of well known portable electronic devices which all come equipped with a power supply adapted to plug into an AC power outlet.

As described previously, the problem with existing power supplies for portable electronic devices is the inability of a user to be able to quickly troubleshoot the power supply and determine whether or not it is operating correctly. The user has no way to easily observe the power supply of the portable electronic device to determine whether or not it is operational. Referring now to FIG. 2, there is illustrated a block diagram of a power supply 202 for a portable electronic device that provides the user with the ability to quickly determine whether or not the power supply is operational. The power supply 202 contains an AC power interface 204. The AC power interface provides an interconnection between the power supply 202 and an AC power source such as that provided by a wall outlet. A device interface 206 provides an interconnection between the power supply 202 and an electronic device. As mentioned previously, the electronic device may comprise any electronic device using a power supply such as a laptop, computer gaming system, personal data assistant or any other type of powered electronic device. The AC interface 204 and device interface 206 are interconnected via a power supply circuitry 208 similar to that illustrated with respect to FIG. 1. The AC interface 204 is connected to the primary side of the transformer 106 within the power supply circuitry 208 and the device interface 206 is connected to a secondary winding of the transformer 106 of the power supply circuitry 208. The power supply circuitry 208 enables AC power to be used to provide power to a connected electronic device.

Connected to the power circuitry 208 is an MCU 210. The MCU 210 is connected to certain nodes within the power supply circuitry 208 to enable the MCU 210 to make voltage and current determinations with respect to the nodes and the power supply circuitry 208. Using these voltage and current measurements within the power supply circuitry 208, the MCU 210 determines whether the power supply 202 is functioning correctly or is malfunctioning. Based upon this determination at the MCU 210, an output may be provided to an indicator 212 within the power supply 202. In a preferred embodiment, the indicator 212 comprises an LED which is turned on or blinks a selected number of times to indicate whether the power supply is operating correctly or to indicate whether the power supply is malfunctioning. In this manner, a user of the portable electronic device may merely look at the LED indicator 212 to determine the operational state of the power supply 202. While the indicator 212 of the preferred embodiment has been described as comprising an LED blinking or lighting to provide an indication, it is equally apparent that a multiple number of LEDs may be used to provide a different colored light to indicate the functioning and malfunctioning states of the power supply. Additionally, a LCD display could be used to provide different codes providing the indication of the functioning or malfunctioning state of the power supply or, alternatively, an audible indicator could be provided to a user to indicate a malfunctioning state of the power supply. As will be readily apparent any type of indicator 212 may be provided that is responsive to a signal provided by the MCU 210 once a determination has been made based upon measurements made with respect to the power supply circuitry 208.

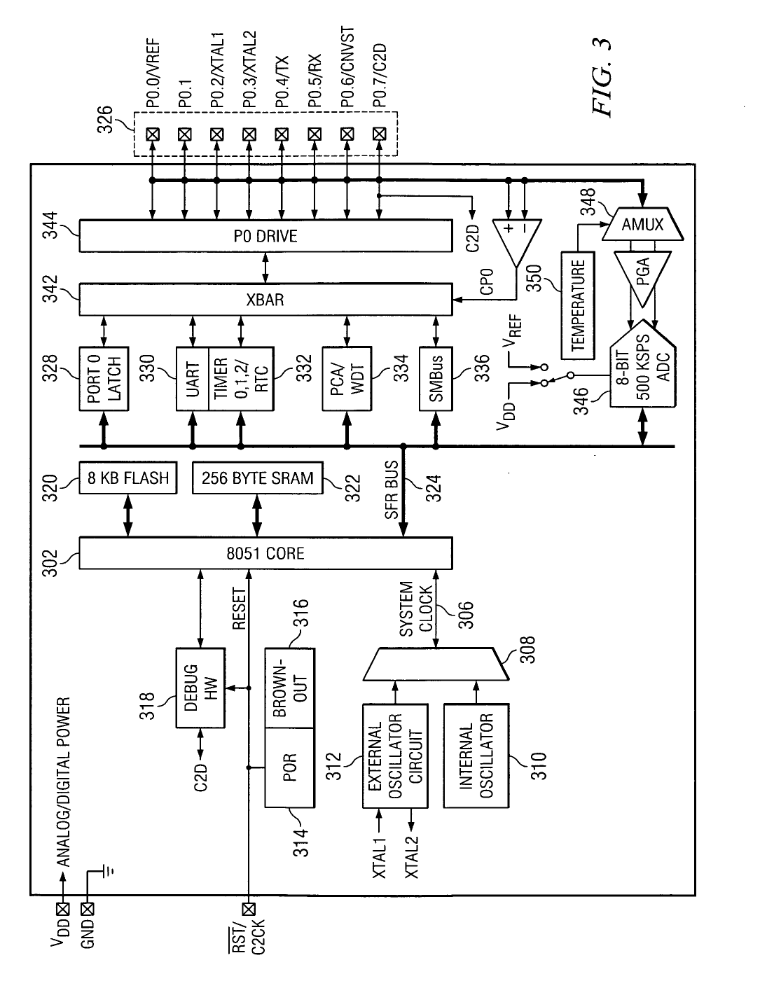

Referring now to FIG. 3, there is illustrated one embodiment of a MCU 210 which may be implemented within the power supply 202 of the present invention. In one embodiment thereof, the MCU 210 may comprise a part number C8051F302MCU manufactured by Silicon Laboratories, Inc. The MCU 210 includes in the center thereof a processing core 302 which is typically comprised of a conventional microprocessor of the type “8051.” An internal clock signal is retrieved on line 306 from a multiplexer 308. The multiplexer 308 is operable to select among multiple clocks. There is provided a signal to the multiplexer 308 from an internal oscillator 310 and an external oscillator 312. Processing core 302 is connected to reset line 404 from an external pin “RST-bar/C2CK.” Also connected to the reset line 304 are a power on reset 314 and a brown out detector 316. Debugging hardware 318 facilitates full speed, nonintrusive, in system debugging. The processing core 302 has associated therewith a plurality of memory resources, those being flash memory 320 and an SRAM memory 322. The flash memory 320 on the MCU 210 allows downloading from a host computer of the test sequences to be applied to the device under test (test program), which will be stored in the MCU flash and survive power cycles. The processing core 302 interfaces with various digital circuitry on the MCU 210 through an on-board digital bus 324, which allows the processing core 302 to interface with the various operating pins 326 that can interface external to the chip to receive values necessary for performing test functionalities. These values may include digital values, output digital values, receive analog values or output analog values. Various digital I/O circuitry are provided, these being serial interface circuitries, such as UART 330 and SMbus interface circuit 336. A number of timers and real time clocks 332 are provided in addition to a latch circuit 328. A PCA/WTD circuit 324 ensures reliable operation by resetting the MCU in the event of erroneous program execution. All of the circuitry 328-336 are interfaceable to the pins 326 through a crossbar device 342. The crossbar device 342 is configurable to interface these devices to select ones of the pins 326. The pins 326 are additionally driven by a pin driver 344. The digital inputs/outputs can also be interfaced to the digital output of an analog-to-digital converter 346 that receives analog input signals from an analog multiplexer 348. The analog multiplexer 348 allows for multiple outputs to be sensed through the pins 326 such that the analog-to-digital converter 346 can be interfaced to various devices. A temperature sensor 350 is additionally connected to provide an input to the analog multiplexer 348.

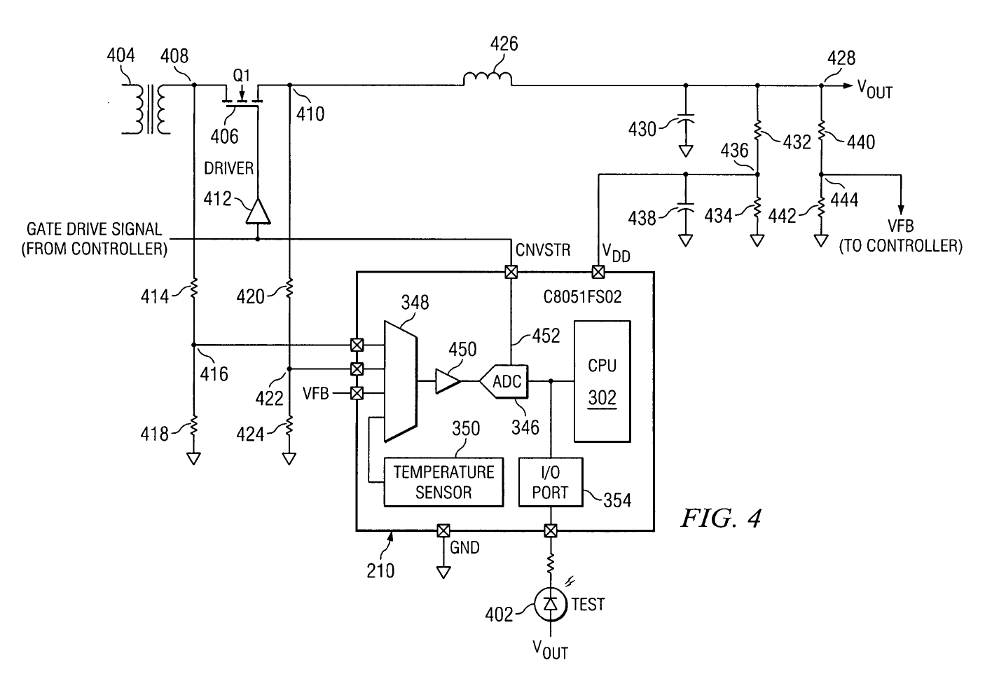

Referring now to FIG. 4, there is illustrated the manner in which the MCU 210 is interconnected with the power circuitry 208 of the PWM power supply to enable the MCU 210 to be able to provide a visual indication via an LED 402. The secondary side of the transformer 404 has connected thereto a switching transistor 406. The drain/source path of the switching transistor 406 is connected to node 408 between the secondary winding of the transformer 404 and node 410. The gate of switching transistor 406 is connected to the output of a driver 412 which has its input connected to the gate drive signal from a PWM controller of the PWM power supply and to the CNVSTR pin of the MCU 210. A resistor 414 is connected between node 408 and node 416. Node 416 is connected to an input pin of the processor 210 to analog multiplexer 348. A resistor 418 between node 416 and ground forms a voltage divider with resistor 414. Resistor 420 is connected between node 410 and node 422. Node 422 is connected to a second input pin of the processor 210 to analog multiplexer 348. Resistor 424, connected between node 422 and ground, forms a voltage divider with resistor 420.

An inductor 426 is connected between node 410 and node 428. Node 428 comprises the voltage out (V_{OUT}) node of the power supply. A capacitor 430 is connected between node 428 and ground. A resistor 432 forming a voltage divider with resistor 434 is connected between node 428 and node 436. Resistor 434 is connected between node 436 and ground. Node 436 is connected to the VDD pin of the MCU 210. A capacitor 438 is connected between node 436 and ground. Another resistor divider network is comprised of resistors 440 and 442. Resistor 440 is connected between node 428 and node 444. Resistor 442 is connected between node 444 and ground. Node 444 is connected to the VFB pin of the MCU 210 and to the analog multiplexer 348. As described previously with respect to FIG. 3, a temperature sensor 350 additionally provides an input to the analog multiplexer 348 of the temperature associated with a MCU 210. The MCU 210 is placed in close proximity to the switching transistor 406 so that the temperatures measured by the temperature sensor 350 will be approximately equivalent to that of the temperature associated with the switching transistor 406. The output of the analog multiplexer 348 is provided through an amplifier 450 to the analog to digital converter 346. The analog to digital converter 346 provides an output to the central processing unit 302 and is actuated by an input via line 452 from the CNVSTR pin. The CPU 302 is also connected to an input/output port 354 that responsive to a signal from the CPU 302 may drive an LED 402 as described herein below.

The MCU 210 that is monitoring the power circuitry 208 of the power supply 202 is connected to a first side of the switching transistor 406 at node 408 and a second side of the switching transistor 406 at node 410. Using the voltage divider network consisting of resistors 414 and 418, a first voltage V₁ on one side of the switch may be determined at node 408. Using the voltage divider network consisting of resistors 420 and 424, a second voltage V₂ may be determined at the second node 410. Each of these voltage values are provided through the analog multiplexer 348 and ADC 346 to the CPU 302 in digital format. The voltage on each side of the switching transistor 406 may be used along with the resistance (R_{SDON}) and temperature of the switching transistor 406 to determine the current flowing through the switching transistor 406.

The output voltage V_{OUT} at node 428 may be determined using the voltage divider network consisting of resistor 440 and 442. This is determined and provided to pin VFB which is provided to the CPU 302 as a digital value through analog-to-digital converter 346. Lastly, the temperature associated with switching transistor 406 may be measured and provided by temperature sensor 350 and provided to the CPU 302 as a digital value via analog multiplexer 348 and analog-to-digital converter 346. The measurement of the voltage values at each of nodes 408 and 406 and the output voltage 428 are initiated by the gate drive signal applied to the gate of switching transistor 406. When this signal goes high, in addition to applying the signal to driver 412 to drive the gate of switching transistor 406, the high signal is applied to the analog-to-digital converter 346 via pin CNVSTR of the processor 210.

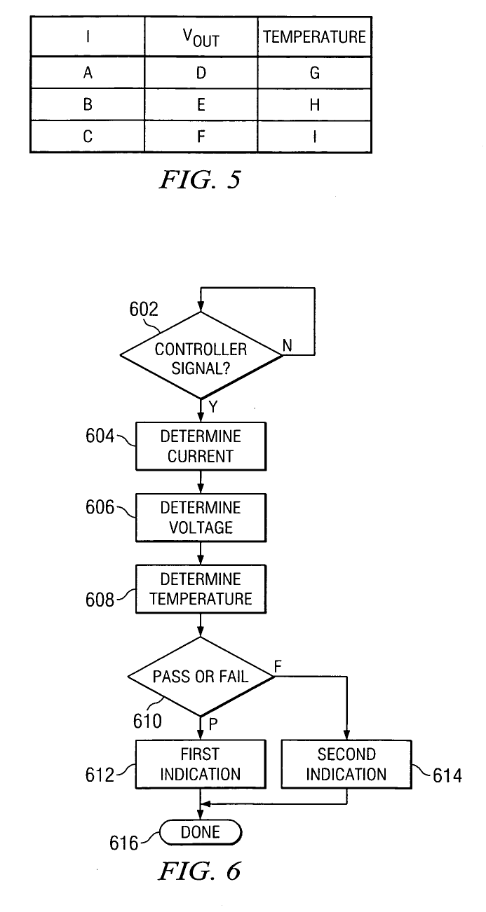

Using the current value associated with switching transistor 406, the temperature value associated with switching transistor 406 and the output voltage value of the power supply, a determination may be made by the central processing unit 302 as to whether the power supply is presently functioning correctly or malfunctioning. The determinations by the central processing unit 402 may be performed in any number of manners. In one manner, a table stored within the flash memory 320 of the processor 210 may be used to look up the associated values of current through switching transistor 406 and output voltage of the power supply and index those with respect to the temperature to determine if the power supply is operating within normal operating parameters. A table illustrating this configuration is illustrated in FIG. 5. Three separate columns of the table include current 502, output voltage 504 and temperature 508. Associated with each current value are an expected output voltage and temperature value for the provided current.

If a determination is made by the central processing unit 302 that these values are consistent, a signal is provided to the LED 402 to indicate that the power supply is operating normally. If the values for current output voltage and temperature do not correspond, the CPU 302 can determine that the power supply is malfunctioning and a malfunctioning indication signal is provided to the LED 402. As described previously with respect to FIG. 2, the LED may provide any number of indications to indicate correct operation or malfunctioning of the power supply. In one configuration, two consecutive blinks of the LED may provide an indication of a correctly operating power supply and three consecutive blinks of the LED may provide an indication of a malfunctioning power supply. This is provided merely by way of example. Other examples include providing different colored LEDs for indicating normal operation and malfunctioning or an audio alarm for a malfunctioning power supply.

Referring now to FIG. 6, there is illustrated a flow diagram describing the operation of the MCU unit 210 monitoring the operation of a power supply 106 is more fully illustrated. Initially, at inquiry step 602 determines if a PWM controller signal has been received at the CNVSTR pin. If not, inquiry step 602 continues to monitor for the PWM controller signal until it is detected. Once the PWM controller signal is detected, the CPU 302 uses measurements from the analog-to-digital converter 346 to determine the current through the switching transistor 406 at step 604, to determine the output voltage of the power supply at step 606 and to determine the temperature associated with the switching transistor from the temperature signal sensor 350 at step 608. Using the determined current, voltage and temperature values, the central processing unit 302 determines at inquiry step 610, whether the power supply passes and is operating in a normal operation mode or fails and is currently malfunctioning. If inquiry step 610 determines that the power supply has passed, a first indication is provided at step 612. If the CPU 302 determines that the power supply is malfunctioning, a second indication is provided at 614. The process then ends at step 616.

Using the above described system and method, a user may quickly determine whether or not a power supply is functioning normally by merely looking at, for example, an LED indication provided on the face of the power supply. If the LED is providing a functioning signal, the user immediately knows that the power supply is operating normally and the problems they are having with the portable electronic device connected to the power supply are associated with another issue. If a malfunctioning signal is perceived by the user, the user may then know to replace their power supply in order to attempt to overcome their problems.

Although the preferred and other embodiments have been described in detail, it should be understood that various changes, substitutions and alterations can be made therein without departing from the spirit and scope of the invention, as defined by the appended claims. For example, two voltage monitor circuits can be used to determine whether a voltage is within a given range. Also, the voltage monitor circuit can be configured to determine if a voltage is above a given threshold or multiple voltages throughout the system can be measured and other algorithms applied to predict impending failures providing the user with an early warning mechanism. As can be appreciated, the voltage monitor of the invention can be utilized in many applications.

What is claimed is:

1. A power supply for a portable device, comprising:
an AC power interface for connecting to an AC power supply;
a DC power interface for connecting to the portable device;
power circuitry for converting AC power from the AC power supply to DC power for the portable device;
a processor coupled to the power circuitry for receiving a plurality of parameters from the power circuitry, the processor determining a status of the power supply responsive to the plurality of parameters and generating a signal indicative thereof; and
an indicator responsive to the signal from the processor for providing an indication of the status of the power supply.

2. The power supply of claim 1, wherein the power circuitry further includes a switching transistor.

3. The power supply of claim 2, wherein the processor is coupled to at least a first side of the switching transistor to detect a first voltage, to a second side of the switching transistor to detect a second voltage and to an output of the power circuitry to detect an output voltage.

4. The power supply of claim 3, wherein the processor determines a current through the switching transistor from the first and the second voltages.

5. The power supply of claim 2, further including a temperature sensor for detecting a temperature.

6. The power supply of claim 5, wherein the temperature sensor is located substantially near the switching transistor.

7. The power supply of claim 2, wherein the processor receives the plurality of parameters responsive to a switching signal to the switching transistor.

8. The power supply of claim 1, wherein the indicator comprises an LED.

9. The power supply of claim 1, wherein the LED blinks a first number of times when the power supply is operating correctly and a second number of times when the power supply is malfunctioning.

10. The power supply of claim 1, wherein the indicator comprises an audio alarm.

11. The power supply of claim 1, further including a table containing associated values of the plurality of parameters to enable the processor to determine a status of the power supply.

12. A power supply for a portable device, comprising:
an AC power interface for connecting to an AC power supply;
a DC power interface for connecting to the portable device;
power circuitry for converting AC power from the AC power supply to DC power for the portable device, the power circuitry including a switching transistor;
a temperature sensor for measuring a temperature associated with the switching transistor;
a processor coupled to the power circuitry for receiving a first voltage from a first side of the switching transistor, a second voltage from a second side of the switching transistor, an output voltage from an output of the power circuitry, and a temperature signal from the temperature sensor, the processor determining a status of the power supply responsive to the first voltage, the second voltage, the output voltage and the temperature signal and generating a signal indicative thereof; and
an LED responsive to the signal from the processor for providing an indication of the status of the power supply.

13. The power supply of claim 12, wherein the processor is coupled to at least the first side of the switching transistor to detect the first voltage, to the second side of the switching transistor to detect the second voltage and to the output of the power circuitry to detect the output voltage.

14. The power supply of claim 12, wherein the processor determines a current through the switching transistor from the first and the second voltage and transistor temperature.

15. The power supply of claim 12, further including a table containing associated values of the current, the output voltage and the temperature signal to enable the processor to determine a status of the power supply.

16. The power supply of claim 12, wherein the temperature sensor is located substantially near the switching transistor.

17. The power supply of claim 12, wherein the processor receives the plurality of parameters responsive to a switching signal to the switching transistor.

18. The power supply of claim 12, wherein the LED blinks a first number of times when the power supply is operating correctly and a second number of times when the power supply is malfunctioning.

19. A method for monitoring an operation of a power supply, comprising the steps of:
converting AC power from an AC power supply to DC power for a portable device;
measuring a plurality of parameters within the power supply;
determining a status of the power supply responsive to the plurality of parameters;
generating a signal indicative of the status of the power supply; and
providing an indication of the status of the status of the power supply responsive to the signal.

20. The method of claim 19, wherein the step of measuring further includes:
detecting a first voltage at a first side of a switching transistor;
detecting a second voltage on a second side of the switching transistor; and
detecting an output voltage at an output of the power supply.

21. The method of claim 20, wherein the step of determining further comprises the step of determining a current through the switching transistor from the first and the second voltages.

22. The method of claim 19, wherein the step of measuring further comprises the step of detecting a temperature.

23. The method of claim 19, wherein the step of measuring further comprises the step of measuring the plurality of parameters responsive to a switching signal to the switching transistor.

24. The method of claim 19, wherein the step of providing further comprises the step of illuminating an LED.

25. The method of claim 24, wherein the step of illuminating further comprises the step of blinking the LED a first number of times when the power supply is operating correctly and a second number of times when the power supply is malfunctioning.

26. The method of claim 19, wherein the step of providing further comprises the step of providing an audio indication.

27. The method of claim 19, wherein the step of determining further comprises the step of accessing a table containing associated values of the plurality of parameters to enable the determination of the status of the power supply.
